(19) United States
(12) Patent Application Publication
(10) Pub. No.: US 2004/0072527 A1
(43) Pub. Date: Apr. 15, 2004

(54) Method and device for filling food into sausage skins

(75) Inventor: Helmut Schroder, Werther (DE)

Correspondence Address: RICHARD M. GOLDBERG, 25 EAST SALEM SREEET, SUITE 419, HACKENSACK, NJ, 07601, US

(73) Assignee: Schroder Maschinenbau KG, Werther (DE)

(21) Appl. No.: 10/682,613

(22) Filed: Oct. 9, 2003

(30) Foreign Application Priority Data
Oct. 10, 2002 (DE) 102 47 230.0

(51) Int. Cl. A22C 25/08; A22C 21/00; A22B 7/00

(52) U.S. Cl. 452/178

(57) ABSTRACT

A method for filling foods into sausage skins, for which the sausage skin (22) is pushed in the form of an endless tube onto a filler pipe (20), the food is extruded as a strand (26) through the filler pipe (20) into the sausage skin (22) and the filled sausage skin is severed at intervals and closed off at the ends, so that sausage-like end products (10) result, characterized in that the strand (26) is severed at the places in the filler pipe (20), at which later on the sausage skin (22) is severed.

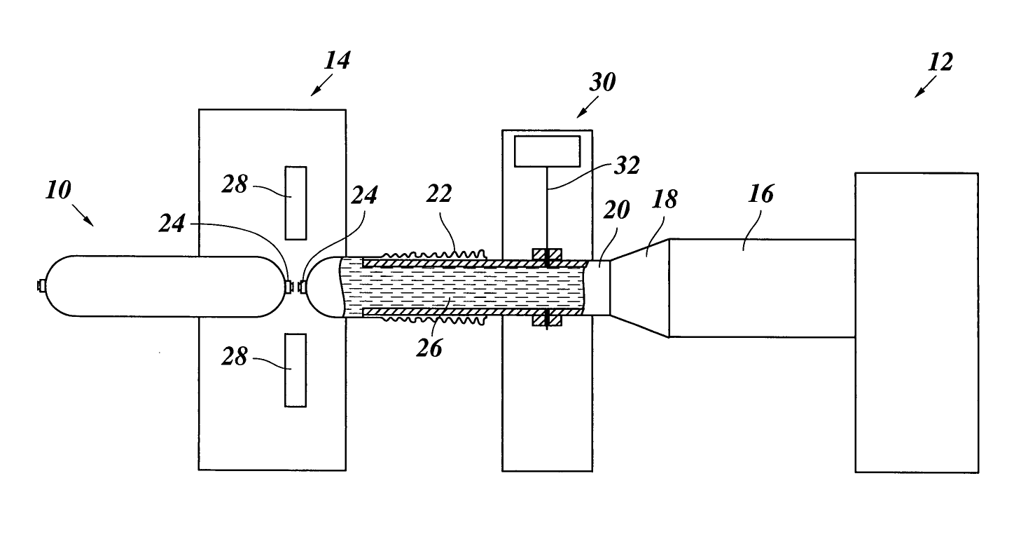

The invention relates to a method for filling foods into sausage skins, for which the sausage skin is pushed in the form of an endless tube onto a filler pipe, the food is extruded as a strand through the filler pipe into the sausage skin and the filled sausage skin is severed at intervals and sealed at the ends, so that sausage-like end products result, as well as to a device for carrying out this method.

Methods and devices of this type (see, for example, the company brochure “Einziehpresse HAMAX 800” of the Maschinenbau Schröder KG) are used not only for producing sausages from finely comminuted meat, but also for producing meat products, for which larger, coherent pieces of meat, such as pork loins, are filled into the sausage skin. For severing the sausage skin and for sealing the ends of the sausage skin, so-called automatic clipping machines are known, which squeeze the sausage skin at the intended severing site, press two metal clips onto the constricted sausage skin and then sever the latter between the two metal clips, so that two sealed sausage skin ends are formed. However, when certain foods are processed, such as pork loins, the problem arises that the individual fiber bundles of the muscle meat are surrounded by a thin tear-resistant and cut-resistant skin, the so-called silver skin, which is difficult to sever in the automatic clipping machine. When the filled sausage skin is squeezed off, it may frequently happen that one or more pieces of a so-called silver skin pass through the squeezed site and, when the sausage skin is severed, are not severed completely, so that the end products, upon leaving the automatic clipping machine, still hang together. As a result, there is appreciable interference with the course of production. Comparable problems also occur when foods are processed, which contain sinews or other filaments, which are difficult to sever.

It is therefore an object of the invention to indicate a method and a device, with which it is possible to fill even foods, which are difficult to sever, into sausage skins, without resulting in interference with the function of the automatic clipping machine.

This objective is accomplished by a method of the type named above owing to the fact that the strand is pre-cut in the filler pipe at places, at which the sausage skin is severed later on. A device for carrying out this method is the object of the independent device claim.

Since the strand of food is not yet surrounded by a sausage skin when it is pre-cut and still has a cross-section, which is significantly larger than it will have later on at the squeezing site in the automatic clipping machine, silver skins, sinews and similar filaments can be severed cleanly during the pre-cutting with the help of a suitable knife, without requiring an excessive cutting force to be exerted. Since the structural limitations, which arise at the automatic clipping machine because the metal clips have to be squeezed in the immediate vicinity of the cutting site, do not exist for the configuration of the pre-cutting device, the pre-cutting process can be configured so that tough filaments are severed reliably. At the same time, for example, a pulling cut can also be carried out or a rotating cutting knife can be used. The cutting position and/or the time of the pre-cutting process is/are coordinated with the cycle of the automatic clipping machine so that, after the strand of food has been pressed further through the filler pipe, the pre-cut places are always at the position, at which the final severing process is to be carried out with the help of the automatic clipping machine. Since the sinews, silver skins and the like have already been severed then, it is essentially necessary to sever only the sausage skin with the help of the automatic clipping machine, so that, even if a conventional automatic clipping machine is used, functional disorders occur significantly less frequently.

Advantageous further developments and refinements of the invention are given in the dependent claims.

Preferably, the pre-cutting device works synchronously with the automatic clipping machine or a comparable severing and sealing device. During the severing process, carried out with the help of the automatic clipping machine, the function of the filling press, with which the food is passed through the filler pipe, is interrupted temporarily. During the pre-cutting process, the advance of the strand should also be interrupted. If the severing and the pre-cutting processes are carried out simultaneously, this can be done without loss of time and therefore without a decrease in the productivity.

Since the food products, which are to be filled into the sausage skin, are essentially incompressible and their volume during the filling process therefore remains essentially constant, it is appropriate to select the position of the pre-cutting device so that the volume of the strand of food between the pre-cutting device and the severing and sealing device is equal to the volume of the end products or to a whole number multiple thereof. By these means, it is ensured that the severing and sealing device, in each cycle of the operation, is effective at the place at which the strand previously was cut through with the pre-cutting device.

In the following, an example of the invention is explained in greater detail by means of the drawing.

The single FIGURE shows a diagrammatic, partially cut-open side view of the inventive device.

The device, shown in the drawing, is used to fill food products, such as pork loins, into sausage skins, so that sausage-like end products 10 result. For this purpose, the device comprises a filling press 12 and a severing and sealing device, which is referred to in the following as the automatic clipping machine 14. The construction and mode of action of these components are known and are therefore not described in detail here.

The filling press 12 has a cylinder 16, which discharges over a conical transition piece 18 into a filler pipe 20, the cross-section of which is already essentially identical with the cross section of the end products 10. A sausage skin 22, in the form of an endless tube, is pushed in gathered form onto the filler pipe 20. The free end of the sausage skin is sealed with the help of the automatic clipping machine 14 by a metal clip 24.

In this state, the operation of the filling press 12 is commenced. The pork loins are compressed in the cylinder 16 and consolidated in the transition piece 18 to the cross-section of the filler pipe 20 and then extruded as a strand 26 through the filler pipe into the sausage skin. At the same time, the end of the sausage skin, sealed by the metal clip 24, is moved in the direction to the left in the drawing and the sausage skin 22 is pulled off from the filler pipe. This process is continued until the section of sausage skin, filled with the strand 26, has reached the desired length of the end product 10. The filling press 12 is then stopped and two tools 28 of the automatic clipping machine 14 are brought together, in order to constrict the filled sausage skin. At the site of the constriction, two metal clips 24 are then squeezed onto the sausage skin with the help of the tools 28 and, in the space between the two metal clips, the sausage skin is severed. Subsequently, the tools 28 are moved apart once again so that a new cycle can commence.

The special feature of the device, described here, consists therein that a pre-cutting device 30 for pre-cutting the strand 26 is disposed at the filler pipe 20 upstream from the sausage skin 22. The pre-cutting device has a cutting knife 32, which can dip into the filler pipe 20, which is interrupted at this place by a slot, in order to sever the strand 26 over its whole cross section. In each case, this pre-cutting process takes place at times, at which the operation of the filling press 12 is interrupted and the tools 28 of the automatic clipping machine 14 are brought together, in order to sever the sausage skin.

The position of the pre-cutting device 30 is selected so that the volume of the strand 26 in the section between the ends of the sausage skin, sealed by the metal clip 24, and the position of the cutting knife 32 is identical with the volume of the end product 10. Therefore, during the next operating cycle of the pre-cutting device 30 and the automatic clipping machine 14, the section of strand 26, severed with the cutting knife 32, is precisely at the site of the tools 28 of the automatic clipping machine. If the strand 26 contains silver skins, sinews or other filaments, which would be difficult to sever with the tools 28, these have already been severed by the pre-cutting process, so that only the sausage skin 22 still has to be severed by the tools 28. Slight positional deviations between the cutting sites of the silver skins, sinews, etc. and the severing site, at which the sausage skin is severed, can be tolerated and, at most, cause only very short end sections of the silver skin to protrude out of the metal clip 24. Accordingly, the end products 10 are severed completely from one another with the automatic clipping machine 14, so that a reliable and stable operation of the device is possible.

1. A method for filling foods into sausage skins, for which the sausage skin (22) is pushed in the form of an endless tube onto a filler pipe (20), the food is extruded as a strand (26) through the filler pipe (20) into the sausage skin (22) and the filled sausage skin is severed at intervals and closed off at the ends, so that sausage-like end products (10) result, characterized in that the strand (26) is severed at the places in the filler pipe (20), at which later on the sausage skin (22) is severed.

2. The method of claim 1, characterized in that the strand (26) is pressed in cyclical fashion through the filler pipe (20) and the severing of the sausage skin (22) and the pre-cutting of the strand (26) take place approximately simultaneously in the phases, in which the pressing process is interrupted.

3. A device for filling foods into sausage skins, with a filling press (12) for extruding the food in the form of a strand (26) through a filler pipe (20), which is surrounded by a sausage skin (22), which is closed off at one end, and with a severing and sealing device (14) for the cyclical severing of the sausage skin (22), filled with the strand (26), and for sealing the ends of the sausage, characterized in that a pre-cutting device (30) for pre-cutting the strand (26), contained in the filler pipe, is disposed at the filler pipe (20) upstream from the sausage skin (22).

4. The device of claim 3, characterized in that the pre-cutting device (30) is disposed in such an axial position at the filler pipe (20), that the volume of the strand (26) between the closed end of the sausage skin and the pre-cutting device (30) is the n-fold volume of an end product (10), which is formed between two consecutive operating cycles of the severing and sealing device (14), n being a whole number equal to or larger than 1.
